(19) United States
(12) Patent Application Publication
(10) Pub. No.: US 2002/0018836 A1
(43) Pub. Date: Feb. 14, 2002

(54) Production of porous bakery products

(76) Inventors: Ralf Diener, Neustadt (DE); Heinrich Eberle, Ludwigshafen (DE); Herbert Seiter, Schindhard (DE)

Correspondence Address: Herbert B. Keil, KEIL & WEINKAUF, 1101 Connecticut Ave., N.W., Washington, DC, 20036, US

(21) Appl. No.: 09/873,282

(22) Filed: Jun. 5, 2001

(30) Foreign Application Priority Data
Jun. 9, 2000 (DE) 10028197.4

(51) Int. Cl. A21D 2/00

(52) U.S. Cl. 426/551

(57) ABSTRACT

Porous bakery products are produced using a leavening agent which comprises a hydrophilic polymeric cellulose derivative.

The present invention relates to a process for producing porous bakery products.

To produce porous bakery products, a gas is produced in the dough before and/or during the baking process, or gas is added to the dough in order to generate porosity in the finished baked article by the gas bubbles. In the simplest case, a gas, generally air, is added to the dough before baking, for example by intensively whipping the dough or one of its constituents before mixing. The best known embodiment is addition of crushed ice to dough. It is also possible to introduce a gas such as air into the dough via nozzles. Processes are also known in which water vapor raises the dough, for example in the production of flaky pastry. The gas usually used, however, is carbon dioxide or carbon dioxide mixed with ammonia and water vapor. Carbon dioxide is generated, for example, biologically in the form of fermentation of dough constituents by yeasts (yeast dough) and/or lactic acid bacteria (in sour dough). As an alternative, or in addition, to the use of yeast or sour dough, carbon dioxide, or the carbon dioxide, ammonia and water vapor mixture, is also generated chemically by baking additives, leavening agents or, commonly, “baking powder”, which are added to the dough.

Leavening agents generally comprise at least one carbonate and, if this does not decompose solely due to temperature elevation, an acid or acidifying substance. In addition to carbonate, they optionally also comprise carbamate. The carbonate and/or carbamate are chosen in accordance with the baked article to be produced, for example potassium carbonate is frequently used for Lebkuchen (spiced cake) or honey cake, sodium hydrogen carbonate (old name: “sodium bicarbonate”) for flat bakery products, ammonium hydrogen carbonate (“ammonium bicarbonate”, abbreviated as “ABC”), as sole carbonate or mixed with ammonium carbamate. The acid or the acidifier must not adversely affect the taste, alone or together with the nonvolatile residues of the carbonate or carbamate. Typically, compounds such as tartaric acid or its salts, for example potassium tartrate, sodium tartrate, potassium hydrogen tartrate and/or calcium tartrate, citric acid, calcium hydrogen phosphate, sodium hydrogen pyrophosphate or sodium aluminum phosphate are used. If the leavening agent comprises an acid or an acidifier, a separating agent is generally added to it which separating agent prevents carbon dioxide being formed prematurely by the carbonate reacting with the acid or the acidifier, flour or starch being customarily used for this. Said ammonium compounds ABC and ammonium carbamate decompose solely due to temperature elevation to at least 60° C. into carbon dioxide, ammonia and water, without residues. At typical baking temperatures, all three components are produced in the gaseous state and therefore all lead to an increase in the porosity of the baked article. These compounds are therefore typically used without adding an acid or an acidifier, so that it is not necessary to add a separating agent. Nevertheless, an anticaking agent is frequently added to these ammonium compounds (that is to say compounds to prevent caking, the formation of lumps or large agglomerates in a powder). Anticaking agents which are customarily used for this purpose are cornstarch, magnesium oxide or magnesium carbonate.

Ullmanns Encyklopädie der technischen Chemie [Ullmann's Encyclopedia of Industrial Chemistry], 3rd edition, Urban & Schwarzenhäuser, Munich—Berlin 1953, head word “Backpulver” [Baking powder] or Ullmann's Encyclopedia of Industrial Chemistry, Sixth Ed., 1999 Electronic Release, Wiley-VCH, Weinheim 1999, head word “Bread and other baked Products”, item 2.6: “Leavening Agents”, give a summarizing overview of the known processes for producing porous bakery products using leavening agents. The preparation of ammonium compounds such as ammonium carbonate, ammonium bicarbonate and ammonium carbamate, by reacting ammonia and carbon dioxide in amounts corresponding to the desired product in aqueous mother liquor, at pressures and temperatures selected according to the product, followed by separating off and drying the precipitate, has also long been known and is described, for example, in Ullmann's Encyclopedia of Industrial Chemistry, Sixth Ed., 1999 Electronic Release, Wiley-VCH, Weinheim 1999, head word “Ammonium Compounds”, especially item 4.: “Ammonium Carbonates”. The preparation of the alkali metal carbonates and alkali metal hydrogen carbonates is also known.

In the known baking processes using customary leavening agents, problems continually occur, because sometimes undesirably large gas bubbles are produced, and, as a consequence thereof, large cavities are produced in the baked article, which extend far beyond the desired pore volume of the pores in the baked article. This leads to an undesirably high reject rate, since, although such a baked article has very large individual cavities, it predominantly contains regions having undesirably low porosity, which makes it hard and frequently also unattractive.

It is known to mix inorganic salts with anticaking agents which prevent or decrease caking of the particles. This technique is employed, for example, in fertilizers which, owing to their seasonal use, must be comparatively storage stable.

DD-A-117 787 teaches that piles of urea granules (particle size of from 1 to 2.5 mm, termed prills) can be stabilized by treating with glues based on carboxymethyl cellulose which are mixed with fillers such as calcium carbonate or calcium oxide. U.S. Pat. No. 3,388,990 discloses fertilizer substances such as urea, ammonium nitrate, ammonium phosphate, ammonium sulfate, ammonium chloride, potassium chloride, lime superphosphate and their mixtures, which are treated with synthetic polymers, such as carboxymethyl cellulose or methyl cellulose and a surface-active substance; U.S. Pat. No. 5,472,476 teaches comparable compositions in which the surface-active substance is an ester of alkylphosphoric acid. According to the teaching of EP-A-246 719, hydroxypropyl cellulose, sodium carboxymethyl cellulose or hydroxypropylmethyl cellulose is used as an aid in water-insoluble-polymer-coated fertilizers, such as urea, ammonium sulfate, ammonium nitrate, ammonium chloride or mixed fertilizers. SU-A-1570255 (unpublished in the original, see Derwent Abstract 94-041345/05) relates to the use of carbamide treated with sodium carboxymethyl cellulose and a surface-active compound for producing mineral fertilizers.

DE-A-28 21 703 teaches salt mixtures of ammonium salts, alkali metal salts and calcium salts of inorganic acids and urea, whose salt particles are covered with a from 0.1 to 50 μm thick protective film against the absorption of moisture. Polysaccharides, inter alia, and their derivatives can be used as protective film, especially starch, cellulose, manna, sodium alginate, methyl cellulose, carboxymethyl starch and carboxymethyl cellulose. EP-A-461 886 discloses a process for coating particles of piperazine, triethylenediamine, ammonium sulfate, ammonium chloride or sodium chloride with water-soluble cellulose esters, and WO-A-98/56595 discloses powders for preparing solutions for lithographic printing processes, with the powders comprising ammonium phosphate or alkali metal phosphates, a solid polysaccharide, for example cellulose or carboxymethyl cellulose, and a preservative.

DE-A-24 35 008 teaches a process for coating water-soluble or dispersible particles, in particular enzymes, with a film-forming polymer, such as methyl cellulose, hydroxybutyl methyl cellulose, sodium carboxymethyl cellulose, hydroxyethyl methyl cellulose or hydroxypropyl methyl cellulose by atomizing an aqueous solution of the polymer in a fluidized bed reactor in which the particles to be coated are charged. WO-A-94/24860 discloses fungicide compositions which, in addition to alkali metal bicarbonate and/or ammonium bicarbonate, alkali metal salts and/or ammonium salts of C₁₀-C₂₂ fatty acids and water-soluble film-forming polymers, such as methyl cellulose or carboxymethyl cellulose salts, also comprise an anticaking agent such as magnesium silicate used to prevent caking of the powder. U.S. Pat. No. 5,468,716 discloses similar fungicide compositions which, in addition, also comprise phosphorus compounds. WO-A-94/24994 and U.S. Pat. No. 5,482,702 teach agglomerates of water-soluble inorganic salts such as ammonium bicarbonate in microcrystalline form which are coated with a hydrophilic polymer such as methyl cellulose or carboxymethyl cellulose. Preparations of these coated agglomerates also comprise anticaking agents, for example magnesium silicate. U.S. Pat. No. 5,482,720 relates to similar compositions which, in addition to carbonate, comprise at least one other crystalline inorganic compound. These compositions also can comprise another anticaking agent such as magnesium silicate. WO-A-96/35408 and WO-A-97/30686 disclose deodorants in which bicarbonate particles which are coated with a polymer, for example a cellulose derivative, are present and in which perfumes are present either separately or as adsorbate to the bicarbonate particles.

It is an object of the present invention to find a process for producing porous bakery products which does not have the disadvantages described at the outset, in particular the formation of undesirably large cavities.

We have found that this object is achieved by a process for producing porous bakery products using a leavening agent, which comprises using a leavening agent which comprises at least one hydrophilic polymeric cellulose derivative.

The inventive process leads to porous bakery products which are uniformly finely porous and do not have undesirably large cavities.

The porous bakery products produced using the inventive process are customary porous bakery products, for example bread, rolls, pretzels, cakes, honey cakes, Lebkuchen [spiced cakes], biscuits, wafers, cookies, salt sticks, small baked goods or the like. Preferably, flat bakery products are produced using the inventive process, that is to say bakery products which have a comparatively small extension in at least one spatial direction, for example Lebkuchen [spiced cakes], biscuits, wafers, cookies, salt sticks or small baked goods.

In the inventive process, a leavening agent is used. The leavening agent comprises at least one carbonate. Optionally, it additionally comprises at least one carbamate. The carbonate and optionally carbamate selected is or are those carbonates or carbamates which are safe to use in foods and, just like their decomposition products, do not lead to an unpleasant taste in the finished bakery products. Suitable carbonates which are present individually or in a mixture are, for example, alkali metal carbonates and alkali metal hydrogen carbonates, in particular sodium carbonate, sodium hydrogen carbonate, potassium carbonate and potassium hydrogen carbonate, and ammonium carbonate and ammonium hydrogen carbonate. Suitable carbamates are, for example, sodium carbamate, potassium carbamate and ammonium carbamate. Also suitable is the customary mixture of ammonium carbonate and ammonium hydrogen carbonate, which can additionally comprise ammonium carbamate. Preference is given to the carbonate ammonium hydrogen carbonate and/or ammonium carbonate and ammonium hydrogen carbonate mixture and the carbamate, if present, ammonium carbamate. (A 1:1 mixture of ammonium hydrogen carbonate and ammonium carbamate is sometimes also termed “ammonium carbonate”.) Very particular preference is given to the carbonate ammonium hydrogen carbonate which is free from intentionally added carbamate.

If the leavening agent used comprises components which do not decompose, or not sufficiently, on heating to typical baking temperatures, the leavening agent additionally comprises an acid or an acidifier. The acid or the acidifier is a compound or mixture of compounds known for this purpose, for example potassium tartrate, sodium tartrate, potassium hydrogen tartrate and/or calcium tartrate, citric acid, calcium hydrogen phosphate, sodium hydrogen pyrophosphate and/or sodium aluminum phosphate. If the leavening agent comprises an acid or an acidifier, a separating agent is also preferably added, which separating agent prevents the premature formation of carbon dioxide by reaction of the carbonate with the acid or the acidifier. Separating agents of this type are known, preference is given to flour and/or starch.

Particularly preferably, the leavening agent consists of the hydrophilic cellulose derivative and ammonium hydrogen carbonate. The mean particle diameters of the carbonates used and, if present, acids or acidifiers, are generally a maximum of 1000 μm, preferably below 700 μm and particularly preferably a maximum of 500 μm. They are generally above 50 μm, preferably above 75 μm and particularly preferably above 150 μm.

The leavening agent comprises at least one hydrophilic cellulose derivative. The cellulose derivative, for obvious reasons, is selected so that it itself and also any thermal decomposition products, in the amounts typically present or formed, are suitable as a food additive and do not adversely affect the taste of the bakery products produced. Preferably, a cellulose derivative is used which is of neutral taste and is permitted under food law.

The hydrophilic cellulose derivative is generally a polymeric cellulose derivative. For the purposes of this invention, the “polymeric cellulose derivative” is a macromolecule which essentially has the polymeric beta-glucosidic base structure of cellulose. The mean molar mass is generally above 2000, preferably above 10,000, and particularly preferably above 20,000.

Suitable cellulose derivatives are, for example, cellulose ethers. These are cellulose derivatives which are formally derived by replacing hydrogen atoms on the hydroxyl groups of cellulose with alkyl and/or arylalkyl groups, in which case these alkyl groups and/or arylalkyl groups can be substituted by functional nonionic, anionic and/or cationic groups. The alkyl groups are customarily C₁-C₈ alkyl groups which can be unbranched or branched. Preferably, the alkyl group is a C₁-C₄ alkyl group, for example methyl, ethyl, n-propyl, isopropyl, n-butyl, sec-butyl, isobutyl or tert-butyl. The alkyl group can be substituted with an aromatic radical to give the arylalkyl group, for example with a phenyl radical. A preferred arylalkyl group is benzyl. The alkyl or arylalkyl group can be functionally substituted, for example with hydroxyl, carboxyl or carboxylate. If carbarboxylate groups are present, corresponding counterions are also present, for example alkali metal ions such as sodium or potassium, or ammonium ions. If only “carboxymethyl cellulose” (frequently abbreviated to “CMC”) is referred to, usually sodium carboxymethyl cellulose is meant (sometimes also abbreviated to “Na-CMC”). Other mixed cellulose ethers can also be used which contain more than one type of alkyl group, arylalkyl group or functionally substituted alkyl group.

Preferred hydrophilic polymeric cellulose derivatives are methyl cellulose, ethyl cellulose, propyl cellulose, carboxymethyl cellulose, hydroxyethyl cellulose, hydroxypropyl cellulose, methyl hydroxyethyl cellulose, methyl hydroxypropyl cellulose, methyl hydroxybutyl cellulose, ethylhydroxyethyl cellulose, carboxymethyl hydroxyethyl cellulose and/or benzyl cellulose. Among carboxymethyl celluloses, the sodium compound is preferred. Particularly preferably, the leavening agent comprises sodium carboxymethyl cellulose, and furthermore particularly preferably, the leavening agent comprises Na-CMC as sole hydrophilic polymeric cellulose derivative.

Particularly preferably, the leavening agent consists of ammonium hydrogen carbonate and Na-CMC.

The cellulose ethers are prepared in a known manner, typically by the action of alkyl halides or arylalkyl halides, epoxides or activated olefins on base (for example sodium hydroxide solution)-activated cellulose. Cellulose ethers are conventional commercial products which are customarily used as thickeners, including in foods. Cellulose ethers are available, for example, under the name “Tylose”, high-purity cellulose ethers for food applications are available under the name “Tylopur”, high purity Na-CMC is available under the name “Tylopur C” from Clariant GmbH.

Preferably, the leavening agent comprises cellulose derivatives which have, in 1.8% strength by weight aqueous solution, a Brookfield viscosity at 20° C. and 20° German hardness of at least 200, preferably at least 400, and particularly preferably at least 450, and at most 1200, preferably at most 1000, and particularly preferably at most 800 mPas.

The cellulose derivative is generally present in an amount of at least 100, preferably at least 300, and particularly preferably at least 500, ppm by weight, for example 1000 ppm by weight, based on the total amount of the leavening agent. The increase in amount above a maximum value, the exceedance of which shows no further improvements and which, depending on the dough mixture to be baked, can readily be determined in a few routine tests, is not expedient for economic reasons alone. Sensory impairment is only observed from extraordinarily high amounts. Generally, the content of cellulose derivative is less than 1, preferably less than 0.5, and particularly preferably less than 0.2, % by weight, based on the total amount of the leavening agent.

The cellulose-derivative-containing leavening agent is prepared by adding the cellulose derivative or the cellulose derivatives during or after preparation of the carbonate, hydrogencarbonate or carbamate. The cellulose derivative is added to the mother liquor in which the carbonate, hydrogencarbonate or carbamate is prepared and from which it is crystallized out, either before or during the preparation of the carbonate, hydrogencarbonate or carbamate, or it is added after the reaction, but before the solid produced is separated off. Optionally, the cellulose derivative is introduced in aqueous solution into a moving bed of the solid carbonate, hydrogencarbonate or carbamate, for instance by spraying. This can be performed, for example, in a dryer (paddle-wheel dryer, rotary kiln) or in a moving bed or fluidized bed. It is also possible to mix solid crystalline carbonate and/or carbamate with solid pulverulent cellulose derivative dry; in this process unsatisfactory high expenditure is usually necessary to achieve a satisfactory result. Particular preference is given to adding the cellulose derivative to the mother liquor from which the carbonate or carbamate is crystallized out. In the, otherwise long known, preparation of ammonium compounds, such as ammonium carbonate, ammonium bicarbonate and ammonium carbamate, by reacting ammonia and carbon dioxide in amounts corresponding to the desired product in aqueous mother liquor, at pressures and temperatures selected according to the product, followed by separating off and drying the precipitate, the cellulose derivative is added to the aqueous mother liquor.

The amount of cellulose derivative added must be set so that the finished product has the desired content of cellulose derivative, which, knowing the mass balance of the preparation process used, is a trivial calculation. When aqueous solutions are sprayed, generally a content of at most 2, preferably 2, and particularly preferably at most 1.5% by weight of the cellulose derivative in water must be set in order not to impair the spraying behavior owing to excessive viscosity. The cellulose derivative content in the spraying solution is generally at least 0.2, preferably at least 0.4, and particularly preferably at least 0.5% by weight, in order to ensure satisfactory economic efficiency.

Optionally, in addition to the cellulose derivative, other aids can be added to the leavening agent; for example known anticaking agents such as cornstarch, magnesium oxide and/or magnesium carbonate or known separating agents such as salts of fatty acids, for example stearic acid, calicum stearate and/or magnesium stearate. However, it is an advantage of the inventive process that such additives are not necessary.

The inventive process is carried out in a customary manner, like known processes for producing bakery products, with the single difference that the leavening agent used comprises at least one hydrophilic polymeric cellulose derivative. Generally, for this purpose a dough is prepared which usually comprises a starch source, such as flour and/or potato starch, a protein source, such as egg white, frequently fats such as butter, oil and/or margarine and usually other ingredients such as sugar, spices, fruits or the like. The ingredients are usually intensively mechanically mixed, for example by stirring or kneading. In addition to the leavening agent, other ingredients can be used which also lead to porosity in the bakery products produced, for example yeast and/or sour dough, and the porosity can also be increased by injecting gases such as air into the dough. The leavening agent can optionally also be premixed with individual dough components prior to the actual dough preparation. In addition, it can be mixed with dry dough components, for example flour, sugar, spices, other flavors and/or dried egg to give a baking mix from which, by adding liquid, a dough is produced and then baked.

The amount of the added leavening agent which comprises at least one polymeric hydrophilic cellulose derivative is chosen such that the desired porosity is set; this may readily be optimized using only a few routine tests. Usually, the amount is chosen so that, per 100 g of the starch source used (for example flour and/or potato starch), at least 1.5, preferably at least 2, and particularly preferably at least 2.35, and at most 3.5, preferably at most 3 and particularly preferably at most 2.85 g of gases (carbon dioxide, ammonia and/or water vapor) are developed. If less porous bakery products are being produced, the amount must be decreased accordingly, and increased accordingly for more porous products.

We claim:

1. A process for producing porous bakery products using a leavening agent, which comprises using a leavening agent which comprises at least one hydrophilic cellulose derivative.

2. A process as claimed in claim 1, wherein the hydrophilic cellulose derivative is a cellulose ether.

3. A process as claimed in claim 1, wherein the hydrophilic cellulose derivative is sodium carboxymethyl cellulose.

4. A process as claimed in claim 1, wherein the hydrophilic cellulose derivative is present in an amount of at least 500 ppm by weight, based on the total weight of the leavening agent.

5. A process as claimed in claim 1, wherein the leavening agent comprises sodium carbonate, sodium hydrogen carbonate, potassium carbonate, potassium hydrogen carbonate, ammonium carbonate, ammonium hydrogen carbonate and/or ammonium carbamate.

6. A process as claimed in claim 5, wherein the leavening agent comprises ammonium hydrogen carbonate and sodium carboxymethyl cellulose.

7. A process as claimed in claim 6, wherein the leavening agent consists of ammonium hydrogen carbonate and sodium carboxymethyl cellulose.

8. A process for preparing an ammonium carbonate, ammonium bicarbonate or ammonium carbamate containing a hydrophilic cellulose derivative by reacting ammonia and carbon dioxide in aqueous mother liquor, separating off and drying the resultant ammonium carbonate, ammonium bicarbonate or ammonium carbamate, which comprises adding the hydrophilic cellulose derivative to the aqueous mother liquor.

9. A process as claimed in claim 8, wherein the cellulose derivative added is sodium carboxymethyl cellulose.

10. A process as claimed in claims 8 or 9, wherein the cellulose derivative is added in an amount of at least 500 ppm by weight and at most 0.2% by weight, based on the cellulose-derivative-containing ammonium carbonate, ammonium bicarbonate or ammonium carbamate which is produced.
